(19) United States
(12) Patent Application Publication
(10) Pub. No.: US 2013/0151230 A1
(43) Pub. Date: Jun. 13, 2013

(54) TECHNIQUES FOR ASSISTING A HUMAN TRANSLATOR IN TRANSLATING A DOCUMENT INCLUDING AT LEAST ONE TAG

(71) Applicants: Zhenyu Chu, Shanghai (CN); Haidong Shao, Sunnyvale, CA (US); Vijay Sainath Thadkal, Bangalore (IN); Yejun Wang, Shanghai (CN); Daniel Virabott Phang, San Francisco, CA (US)

(72) Inventors: Zhenyu Chu, Shanghai (CN); Haidong Shao, Sunnyvale, CA (US); Vijay Sainath Thadkal, Bangalore (IN); Yejun Wang, Shanghai (CN); Daniel Virabott Phang, San Francisco, CA (US)

(73) Assignee: Google Inc., Mountain View, CA (US)

(21) Appl. No.: 13/565,148

(22) Filed: Aug. 2, 2012

Related U.S. Application Data
(63) Continuation of application No. PCT/CN2011/083802, filed on Dec. 12, 2011.

(51) Int. Cl. G06F 17/28

(52) U.S. Cl. 704/2

(57) ABSTRACT

A computer-implemented method technique includes receiving, at a server, a document including at least one tag. The technique replaces each tag of the document with a placeholder to obtain a modified document. The technique obtains a machine translation of the modified document to obtain a first translated document. The technique provides the first translated document to a human translator at a computing device. The technique receives, at the server, one or more manual translations of the document having been previously generated by one or more other human translators and having had any tags replaced by placeholders. The technique generates a probability score for each of the one or more manual translations based on a level of similarity between portions of text and placeholder association. The techniques then provide the one or more manual translations and the corresponding one or more probability scores to the human translator at the computing device.

### CROSS-REFERENCE TO RELATED APPLICATION

This application is a continuation of International Application No. PCT/CN2011/083802 filed on Dec. 12, 2011. The entire disclosure of the above application is incorporated herein by reference.

### FIELD

The present disclosure relates to language translation and, more particularly, to techniques for assisting a human translator in translating a document including at least one tag.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user may access a website from a computing device via a network such as the Internet. The website may display a webpage to the user via a web browser executing on the computing device. The webpage may include images, videos, text, or a combination thereof, to be displayed to the user on a display associated with the computing device. The displayed webpage is a visual representation of an underlying source document. The source document can include text as well as one or more tags associated with a portion of text. Each of the tags may be indicative of a characteristic (bold, italics, underlined, hyperlink, alignment, position, font, etc.) of the associated portion of text. For example, the tag may include a markup language tag defined by the hypertext markup language (HTML), the extensible markup language (XML), or the like. A web browser interprets the source document to generate the webpage, which in turn is viewed by the user.

### SUMMARY

A computer-implemented method technique for assisting a human translator in translating a document including at least one tag is presented. The technique includes receiving, at a server including one or more processors, the document for translation from a source language to a target language, the at least one tag associated with a first portion of text in the document. The technique also includes identifying, at the server, a location of each tag within the document. The technique also includes replacing, at the server, each tag with a placeholder at the corresponding identified location to obtain a modified document. The technique also includes generating, at the server, a machine translation of the modified document to obtain a first translated document. The technique also includes providing, from the server, the first translated document to a computing device associated with the human translator. The technique also includes receiving, at the server, a selection of a second portion of text in the first translated document by the human translator via the computing device, the second portion of text having an associated placeholder. The technique also includes comparing, at the server, the second portion of text to one or more manual translations of the document, each of the one or more manual translations of the document having been previously generated by one or more other human translators, each of the one or more manual translations of the document having had any tags replaced by placeholders and being stored in a translation datastore. The technique also includes generating, at the server, a probability score for each of the one or more manual translations of the document, the probability score for a specific manual translation of the document being based on (i) a level of similarity between the second portion of text in the first translated document and a third portion of text in the specific manual translation of the document and (ii) whether the specific manual translation of the document has a placeholder associated with the third portion of text. The technique also includes providing, from the server, the one or more manual translations of the document and the one or more corresponding probability scores to the human translator at the computing device. The technique also includes receiving, at the server, input from the human translator, the input including at least one of: (i) edits made by the human translator to the second portion of text at the computing device and (ii) a selection of one of third portions of text of one of the manual translations of the document based on the one or more probability scores. The technique also includes generating, at the server, a second translated document by: (i) incorporating edits made by the human translator to the second portion of text of the first translated document, (ii) replacing the second portion of text of the first translated document with the selected third portion of text from one of the manual translations of the document, and (iii) replacing each placeholder in the first translated document with its corresponding tag from the document. The technique further includes providing, from the server, the second translated document to the human translator at the computing device.

Another computer-implemented technique is also presented. The technique includes receiving, at a server including one or more processors, a document for translation from a source language to a target language, the document including at least one tag associated with a first portion of text in the document. The technique also includes replacing, at the server, each tag of the document with a placeholder to obtain a modified document. The technique also includes obtaining, at the server, a machine translation of the modified document to obtain a first translated document, the first translated document having at least one placeholder associated with a second portion of text. The technique also includes providing, from the server, the first translated document to a human translator at a computing device. The technique also includes receiving, at the server, one or more manual translations of the document, the one or more manual translations having been previously generated by one or more other human translators, each of the one or more manual translations having had any tags replaced by placeholders. The technique also includes generating, at the server, a probability score for each of the one or more manual translations, wherein the probability score for a specific manual translation is based on: (i) a level of similarity between the second portion of text in the first translated document and a third portion of text in the specific manual translation of the document and (ii) whether the third portion of text has an associated placeholder. The technique further includes providing, from the server, the one or more manual translations and the corresponding one or more probability scores to the human translator at the computing device.

A system is also presented. The system includes a tag identification module, a placeholder insertion module, a translation control module, and a translation scoring module. The tag identification module receives, at a server including one or more processors, a document for translation from a source language to a target language, the document including at least one tag associated with a first portion of text in the document. The placeholder insertion module replaces, at the server, each tag of the document with a placeholder to obtain a modified document. The translation control module obtains, at the server, a machine translation of the modified document to obtain a first translated document, the first translated document having at least one placeholder associated with a second portion of text. The translation control module also provides, from the server, the first translated document to a human translator at a computing device. The translation control module also receives, at the server, one or more manual translations of the document, the one or more manual translations having been previously generated by one or more other human translators, each of the one or more manual translations having had any tags replaced by placeholders. The translation scoring module generates, at the server, a probability score for each of the one or more manual translations, wherein the probability score for a specific manual translation is based on: (i) a level of similarity between the second portion of text in the first translated document and a third portion of text in the specific manual translation of the document and (ii) whether the third portion of text has an associated placeholder. The translation control module also provides, from the server, the one or more manual translations and the corresponding one or more probability scores to the human translator at the computing device.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of an example network system that includes a translation server configured to perform a translation assistance technique according to some implementations of the present disclosure;

FIG. 2 is a functional block diagram of an example translation server of FIG. 1;

FIG. 3 is a functional block diagram of an example translation assistance module of the translation server of FIG. 2;

FIG. 4 is a schematic illustration of an example display of a user interface generated by the translation assistance module of FIG. 2;

FIG. 5 is a flow diagram of a technique for assisting a human translator in translating a document including at least one tag according to some implementations of the present disclosure; and

FIG. 6 is a flow diagram of another technique for assisting a human translator in translating a document including at least one tag according to some implementations of the present disclosure.

### DETAILED DESCRIPTION

As previously described, a webpage may be a visual representation of an underlying source document that includes various tags that indicate characteristics of associated portions of text. The source document (or “document”) may be accessed by or provided to a user of a computing device through a web server over a network such as the Internet. A web browser at the user's end may then interpret the document and generate the webpage viewed by the user. Given the worldwide access to the Internet, a webpage may be viewed by a plurality of different users, each of which may speak and/or understand different languages. Therefore, providing webpages in a plurality of different languages may be desirable. Accordingly, the source documents associated with webpages may be translated into different languages when requested.

Source documents may be translated according to a variety of different techniques. Machine translation, e.g., translation by a computer, may be faster and less expensive than manual translation, e.g., translation by a human translator. Due to various language anomalies, a manual translation of a document may be more accurate or otherwise more preferable than a machine translation. Human translators performing the manual translation of the document, however, may not understand the tags in the document, which may lead to a manual translation of the document that includes incorrect formatting or other characteristics due to incorrectly located or incomplete tagging.

Accordingly, techniques are presented for assisting a human translator in translating a document that includes at least one tag. The techniques generally provide for more accurate document translation and/or improved human translator experience. The techniques include receiving, at a server, a document for translation from a source language to a target language. The target is different than the source language. The document also includes at least one tag associated with a first portion of text of the document. For example, the server may receive the document from a web server in response to a request from a computing device operated by the human translator. The techniques may identify locations of the at least one tag in the document. The techniques may then replace any tags in the document with placeholders to obtain a modified document. After replacing tags with placeholders, the techniques may generate a machine translation of the modified document using suitable machine translation techniques to obtain a first translated document.

The techniques may also provide the first translated document to the human translator at the computing device. The human translator may edit the first translated document. As previously mentioned, the techniques generally provide for assisting the human translator in editing the first translated document. Specifically, the human translator may select a second portion of text in the first translated document. The second portion of text has placeholders associated with it (the placeholders having replaced a tag in the document). The second portion of text is then transmitted to the server. The server may search one or more manual translations of the document stored in a translation datastore, where the one or more manual translations have been previously generated by one or more other human translators. The one or more manual translations may have also had any tags identified and replaced by placeholders similar to the generation of the modified document. Specifically, the server may search for third portions of text in the one or more manual translations, the third portions of text being at least substantially similar to the second portion of text. In some cases, one or more third portions of text may be identical to the second portion of text.

The techniques can also generate probability scores for the third portions of text of the one or more manual translations. The probability score for a specific manual translation (a specific third portion of text) can be based on (i) a level of similarity between the second portion of text and the specific third portion of text and/or (ii) whether the third portion of text has an associated placeholder. For example, the probability score can be generated according to the following criteria: (1) a first range of scores for third portions of text that are exact matches to the second portion of text and also have the associated placeholder; (2) a second range of scores for third portions of text that are exact matches to the second portion of text but do not have the associated placeholder; (3) a third range of scores for third portions of text that are partial matches to the second portion of text and also have the associated placeholder; and (4) a fourth range of scores for third portions of text that are partial matches to the second portion of text but do not have the associated placeholder. The first range of scores can be greater than the second range of scores, the second range of scores can be greater than the third range of scores, and the third range of scores can be greater than the fourth range of scores. The probability score within the particular range of scores depends on the level of similarity between the third portion of text and the second portion of text (the degree of matching).

The techniques may then provide the third portions of text (or the one or more manual translations) and the corresponding probability scores to the human translator. The human translator may then select one of the third portions of text based on the probability scores. The techniques can generate a second translated document, which represents the human translator's manual translation. The techniques can generate the second translated document by: (i) incorporating edits made by the human translator to the second portion of text, and/or (ii) replacing the second portion of text with the selection of one of the third portions of text. The techniques may also insert tags from the document into the second translated document at the placeholder locations. The techniques may then provide the second translated document to the human translator at the computing device. The second translated document may also be stored, e.g., in the translation datastore, for use in future translation assistance operations and/or other translation-related operations, e.g., translation statistics.

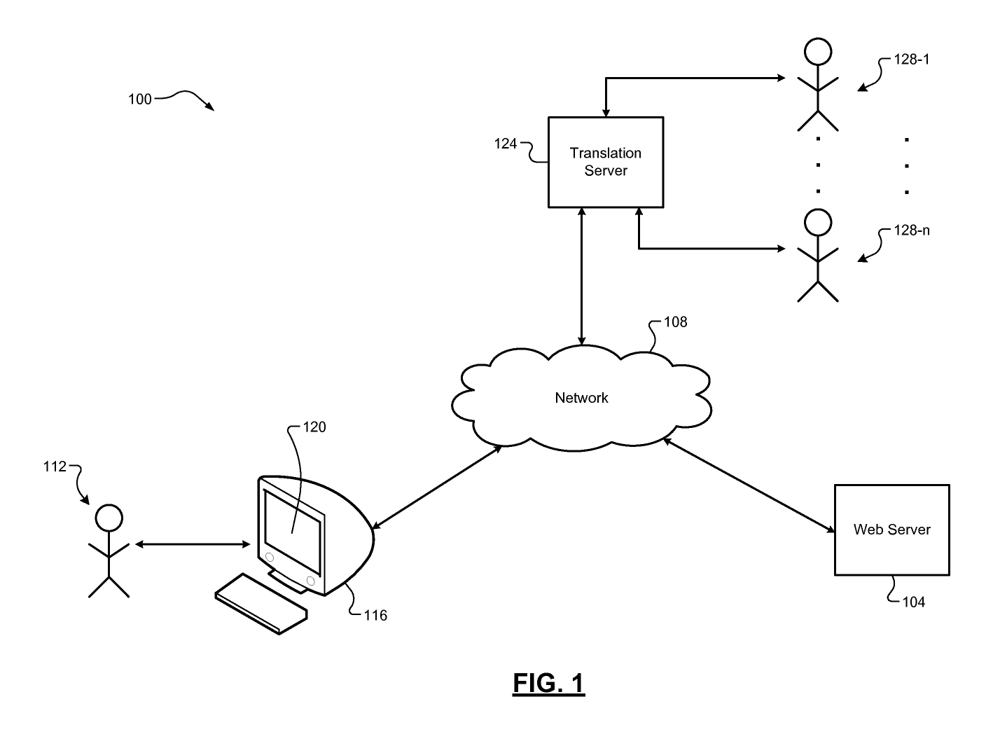

Referring now to FIG. 1, an example network system 100 is illustrated. The example network system 100 includes a translation server 124 configured to a perform translation assistance technique according to some implementations of the present disclosure on a document that includes at least one tag. It is appreciated that while a single tag is often described or referred to herein, the document may include a plurality of tags and therefore the translation assistance techniques may include the identification and replacement of a plurality of tags with a plurality of placeholders, respectively. The tag can be associated with a portion of text within the document. For example, the tag may be a markup language tag corresponding to a markup language such as HTML, XML, or the like.

A web server 104 may store and selectively provide the document to a location in a network 108. While one web server 104 is shown, it is appreciated that more than one web server 104 may be implemented. For example, the network 108 may include a wide area network (WAN) such as the Internet, a local area network (LAN), or a combination thereof. A user 112 may selectively access the document from the web server 104 via a computing device 116 on the network 108. The techniques of the present disclosure are directed to assisting the user 112 in translating the document provided by the web server 104. The user 112, therefore, may hereinafter be referred to as the “human translator 112”. The computing device 116 may also include a display 120 that displays a web page using a web browser that interprets the document.

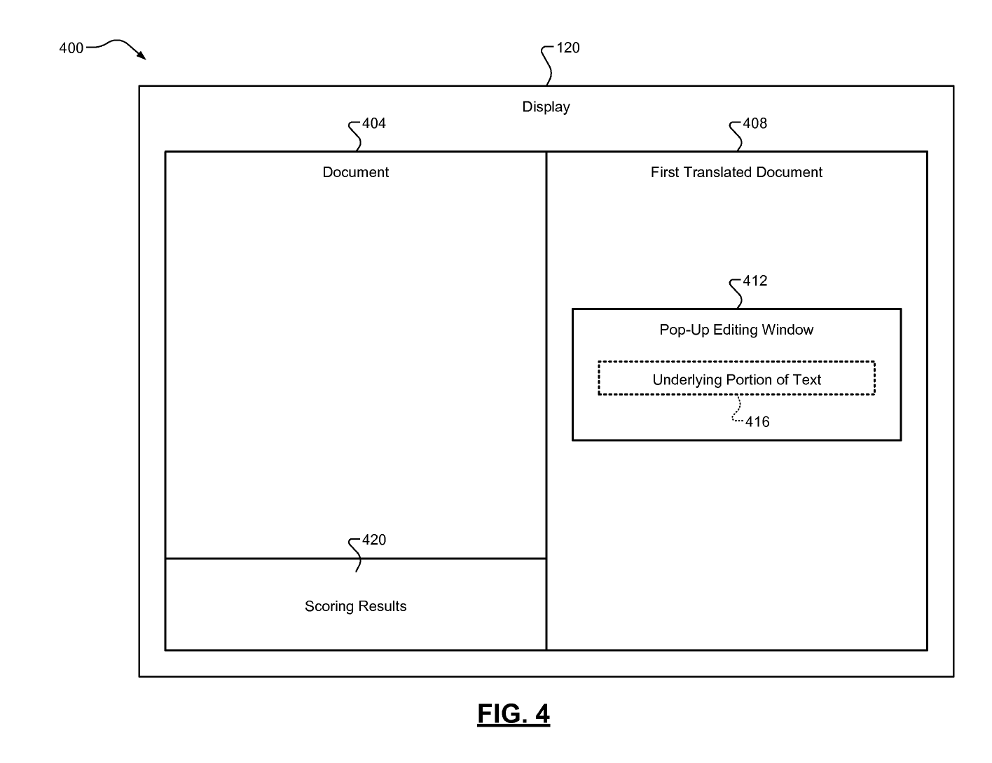

The display 120 may display a user interface generated by the translation server 124 according to some of the implementations of the present disclosure (described in detail later and shown in FIG. 4). The computing device 116 may also include other components, such as a user interface, one or more processors, and the like. The translation server 124 can also be located at a location on the network 108. While one translation server 124 is shown, it should be appreciated that one or more translation servers 124 may collectively implement the techniques of the present disclosure, e.g., parallel translation servers. The translation server 124 may communicate via the network 108 with the user 112 (via computing device 116) and/or the web server 104. The translation server 124 is selectively provided with the document for translation from a source language to a target language by the web server 104, the target language being different than the source language. For example only, the source language may be English and the target language may be Chinese. The source and target languages, however, may each be any other suitable language.

The translation server 124 may also receive input from one or more other human translators 128-1 . . . 128-n (n≧1, collectively referred to as other human translators 128). The input from the other human translators 128 can include manual translations of the document. Alternatively, the input from the other human translators 128 may include manual translations of other documents having the same or similar portions of text as the document. For example, the other human translators 128 may provide their input via other computing devices (not shown) similar to computing device 116. In addition, while the other human translators 128 are shown as being local to the translation server 124, it should be appreciated that the other human translators 128 may be located elsewhere with respect to the network 108 and may therefore provide their input via the network 108.

The translation server 124 may perform the translation assistance techniques of the present disclosure. Specifically, the translation server 124 may assist the human translator 112 in translating the document provided by the web server 104 from a source language to a target language. The other human translators 128 may also provide input that is used in assisting the human translator 112 in translating the document. Specifically, the other human translators 128 may provide one or more manual translations of the document (and/or other documents). For example, the other human translators 128 may have previously provided the one or more manual translations. In some implementations, the other human translators 128 may have provided the one or more manual translations that had placeholders inserted in place of tags before storing the one or more manual translations in a translation datastore (as described below).

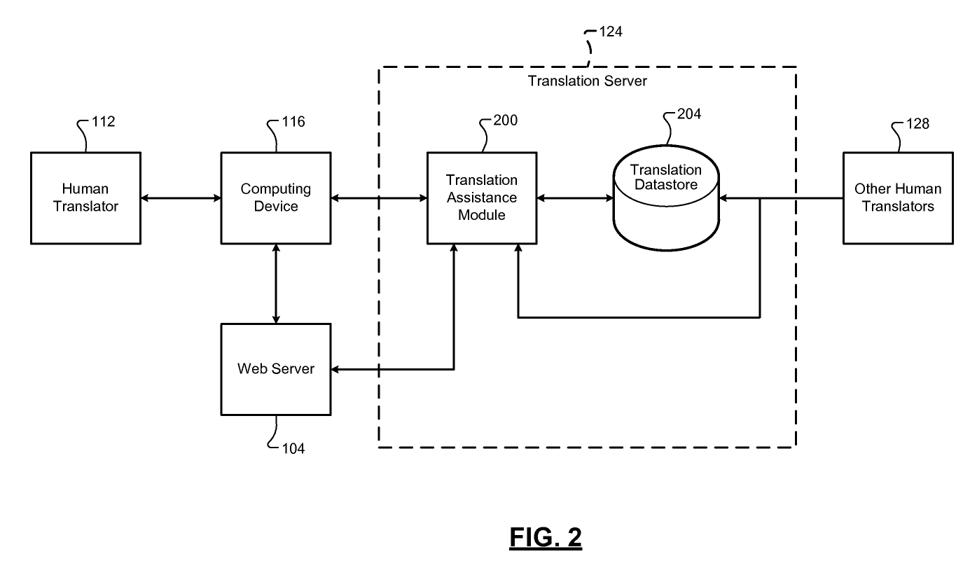

Referring now to FIG. 2, an example of the translation server 124 according to some implementations of the present disclosure is illustrated. The translation server 124 can include a translation assistance module 200 and a translation datastore 204. While the translation datastore 204 is shown to be part of the translation server 124, the translation datastore 204 could instead be located external to the translation server 124, e.g., in another server, or elsewhere with respect to the network 108. The other human translators 128 can provide the one or more manual translations of the document (and/or other documents) to the translation server 124. The one or more manual translations may then have tags identified and replaced by placeholders.

For example, the translation assistance module 200 may identify and replace the tags in the one or more manual translations (similar to the identification and replacement of tags in the document). The tags can be identified by parsing the document to identify specific tags, e.g., brackets <and >, commonly associated with tags (described in detail below). Alternatively, another module (not shown) may also be used to identify tags and replace the tags with placeholders in the one or more manual translations. The translation datastore 204 may then store one or more manual translations of the document having placeholders in place of tags. The translation assistance module 200 uses the one or more manual translations in the translation datastore 204 in providing the human translator 112 with potential translations (and corresponding probability scores) of portions of text in a machine translation of a modified document (a first translated document).

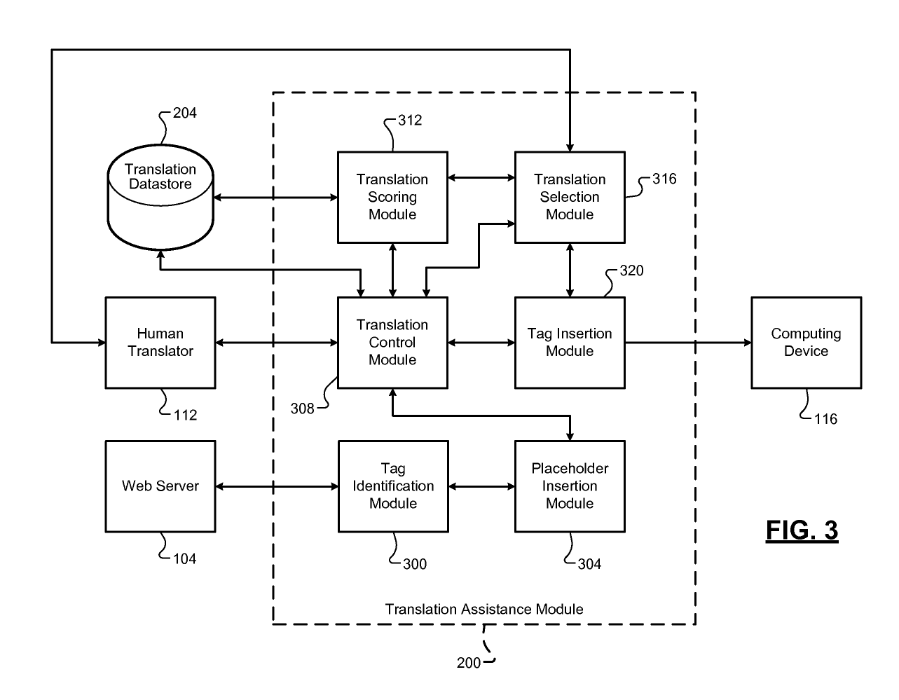

Referring now to FIG. 3, an example translation assistance module 200 is illustrated. The translation assistance module 200 can include a tag identification module 300, a placeholder insertion module 304, a translation control module 308, a translation scoring module 312, a translation selection module 316, and a tag insertion module 320. It should be appreciated that the translation assistance module 200 may also include other components such as one or more processors, memory, and the like.

The tag identification module 300 can receive the document to be translated from a source language to a target language. The at least one tag in the document can be associated with a portion of text in the document, which is hereinafter referred to as a first portion of text. As shown, the tag identification module 300 can receive the document from the web server 104. For example, the web server 104 may provide the document to the tag identification module 300 in response to a translation request by the human translator 112 (via the computing device 116 connected to the network 108. Alternatively, the human translator 112 could directly provide the document to the tag identification module 300 using suitable data transfer techniques.

The tag identification module 300 identifies the at least one tag in the document. The tag identification module 300 can parse the entire document and determine locations of the at least one tag. Specifically, the tag identification module 300 can identify tags by identifying particular characters, e.g., brackets < and >. Typically, tags are found in pairs. More specifically, a tagging typically includes a first tag indicating a start of the formatting and a second tag indicating an end of the formatting. For example only, a pair of bold tags may illustrated in the phrase “<b>Hello World</b>”, where <b> is the first tag (or the start tag) and </b> is the second tag (or end tag). Alternatively, a tag may refer to the collective pair of first and second tags (<b> and </b>).

The placeholder insertion module 304 receives the document and the identified tag locations from the tag identification module 300. The placeholder insertion module 304 replaces each tag with a placeholder to obtain a modified document. The placeholders may be generic. In other words, the same placeholders may be used for all tags (bold, italic, underline, hyperlink, etc.). For example only, in the example above the portion of text “<b>Hello World</b>” may have the bold tags replaced with placeholders to obtain “<0>Hello World</0>”. The placeholders in this example are represented by the character “0”. Other characters may also be used. It should be noted that the second placeholder maintains the end indication “/” from the second tag. Additionally, in some implementations different placeholders may be used for different tags (0 for bold, 1 for italic, 2 for underline, etc.).

The translation control module 308 may then generate a machine translation of the modified document to obtain the first translated document. The translation control module 308 can generate the first translated document using any suitable machine translation technique. The translation control module 308 may then provide the first translated document to the human translator 112, e.g., at the computing device 116. The human translator 112 can select a portion of text in the first translated document. The selected portion of text is hereinafter referred to as a second portion of text. The second portion of text may also have placeholders associated with it, the placeholders having previously been inserted to replace a tag. For example, the human translator 112 may select the second portion of text after determining that the second portion of text has an error that the human translator 112 wishes to correct. The human translator 112 may be provided a pop-up window at display 120 of the computing device 116 in response to the selection of the second portion of text (described in detail below and shown in FIG. 4).

The translation control module 308 receives the second portion of text selected by the human translator 112. The translation control module 308 can search the one or more manual translations stored in the translation datastore 204 for previous translations of the second portion of text. Specifically, the translation control module 308 can search for third portions of text of the one or more manual translations that are at least substantially similar to the second portion of text. In other words, the one or more manual translations may not include third portions of text that are exact matches of the second portion of text. The translation control module 308, therefore, can retrieve the third portions of text (of the corresponding one or more manual translations) for scoring by the translation scoring module 312. In some cases, however, one or more third portions of text can be an exact match to the second portion of text.

The translation datastore 204 may store more than the one or more manual translations of the document. Specifically, in some implementations the translation datastore 204 can include previous manual translations of other documents that also include third portions of text at least substantially similar to the second portion of text selected by the human translator 112. For example only, these other documents may include documents that cite or link to the document provided by the web server 104. The translation control module 308 or the translation scoring module 312 may determine whether these third portions of text are at least substantially similar to the second portion of text (as described below). The translation control module 308, therefore, may then select or retrieve a subset of the manual translations stored in the translation datastore 204.

The translation scoring module 312 generates a probability score for each of the third portions of text of the one or more manual translations stored from the translation datastore 204. As previously mentioned, the translation scoring module 312 can also generate a probability score for third portions of text from a subset of the one or more manual translations stored in the translation datastore 204. More specifically, the translation scoring module 312 can generate the probability score for a specific third portion of text (corresponding to a specific manual translation) based on (i) a level of similarity between the second portion of text and the specific third portion of text, and/or (ii) whether the third portion of text has an associated placeholder.

The translation scoring module 312 can generate the probability score according to the following criteria: (1) a first range of scores for third portions of text that are exact matches to the second portion of text and also have the associated placeholder; (2) a second range of scores for third portions of text that are exact matches to the second portion of text but do not have the associated placeholder; (3) a third range of scores for third portions of text that are partial matches to the second portion of text and also have the associated placeholder; and (4) a fourth range of scores for third portions of text that are partial matches to the second portion of text but do not have the associated placeholder. The first range of scores can be greater than the second range of scores, the second range of scores can be greater than the third range of scores, and the third range of scores can be greater than the fourth range of scores. The probability score within the particular range of scores depends on the level of similarity between the third portion of text and the second portion of text (the degree of matching). The degree of matching refers to a relative level of similarity between documents, where a higher degree of matching corresponds to a higher level of similarity between the documents, e.g., the document and the selected manual translation, or rather the second portion of text and the selected third portion of text.

The translation selection module 316 determines a selected third portion of text (a selected one of the one or more manual translations) to obtain a selected manual translation. The selected manual translation may be selected by the human translator 112 via the computing device 116. For example, the human translator 112 may be provided with the third portions of text (of the one or more manual translations) and the corresponding probability scores, and may then select one of the choices to obtain the selected manual translation.

In some cases, the selected manual translation may not be the manual translation having the highest probability score, e.g., when the human translator 112 disagrees with the scoring. Alternatively, in some implementations the translation selection module 316 may automatically select the third portion of text from the one or more manual translations having a higher probability score than a remainder of the one or more manual translations. Moreover, in some cases the human translator 112 may not select any of the third portions of text. For example, the human translator 112 may merely provide his/her own edits to the second portion of text. For example only, this may occur when no previous manual translations of the document (or in particular, the second portion of text) have previously been translated by another human translator.

In conjunction with the translation selection module 316, the translation control module 308 may generate a second translated document. The second translated document can represent the manual translation of the document by the human translator 112. The translation control module 308 may generate the second translated document by incorporating any edits made to the second portion of text by the human translator 112 as well as replacing the second portion of text with the selected third portion of text (if selected by the human translator 112).

The translation control module 308 may output the second translated document (and in some cases, the document) to the tag insertion module 320. The tag insertion module 320 can then insert the tags from the document into the second translated document at the placeholder locations. The tag insertion module 320 can then output the second translated document (including tags) to the computing device 116, e.g., to the human translator 112. The tag insertion module 320 can also store the second translated document in the translation datastore 204 for use in future translation assistance operations and/or other translation-related operations, e.g., translation statistics.

Referring now to FIG. 4, an example display 400 of a user interface is illustrated. The user interface 400 may be generated by the translation assistance module 200 of the translation server 124. For example, the display 400 may be provided to the human translator 112 at the display 120 of the computing device 116 via the network 108. It should be appreciated that the configuration of the display 400 is merely exemplary in nature and therefore other configurations may also be implemented. The display 400 can include a split-screen view having the document displayed in a left area 404 and the first translated document displayed in a right area 408. The human translator 112 may generally interact in the right area 408, e.g., providing edits to the first translated document. Specifically, the human translator 112 may select the second portion of text from the first translated document. For example, the second portion of text may be a phrase, a sentence, or a paragraph. The second portion of text may also be other combinations of words and characters. The second portion of text can also have associated placeholders (having previously replaced a tag).

When the human translator 112 selects the second portion of text, a pop-up editing window 412 may be displayed. For example, the pop-up editing window 412 may be displayed on top of (overlaying) an area 416 where the second portion of text was previously located and selected by the human translator 112. The human translator 112 may provide edits to the second portion of text via the pop-up editing window 412. For example, the pop-up editing window 412 may display the second portion of text to the human translator 112 along with the placeholders. In other words, the pop-up editing window 412 may not show the tag associated with the second portion of text. The absence of the tag in the second portion of text may allow the human translator 112 to more easily understand the second portion of text and provide edits to the second portion of text. As previously described, the translation assistance techniques may also provide the human translator 112 with the third portions of text (of the one or more manual translations) and their corresponding probability scores.

A scoring region 420 can be located on the left side of the display 400 and below the left area 404 and may display the third portions of text and their corresponding probability scores to the human translator 112. For example, the third portions of text may be ranked according to their probability scores, e.g., from a highest probability score to a lowest probability score. Additionally, users, e.g., the human translator 112 and/or the other human translators 128, may provide input such as a rating of a particular third portion of text. This additional input may also be factored into the generation of the probability scores and the corresponding rankings for presentation to the human translator 112. The human translator 112 may select one of the third portions of text based on the probability scores. For example, the human translator 112 may select one of the third portions of text having a higher probability score than a remainder of the third portions of text.

Alternatively, the human translator 112 may select another one of the third portions of text. For example, the human translator 112 may determine that the highest ranked third portion of text is incorrect, less accurate than other third portions of text, or otherwise inappropriate. Additionally, in some cases the human translator 112 may not select any of the third portions of text, e.g., the human translator 112 may merely provide edits to the second portion of text. Any edits made by the human translator 112 (such as via the pop-up editing window 412) and any selection made by the human translator 112 of one of the third portions of text may then be provided to the translation server 124 to be used in generating the second translated document (having edits/selections incorporated and having placeholders replaced by original tags).

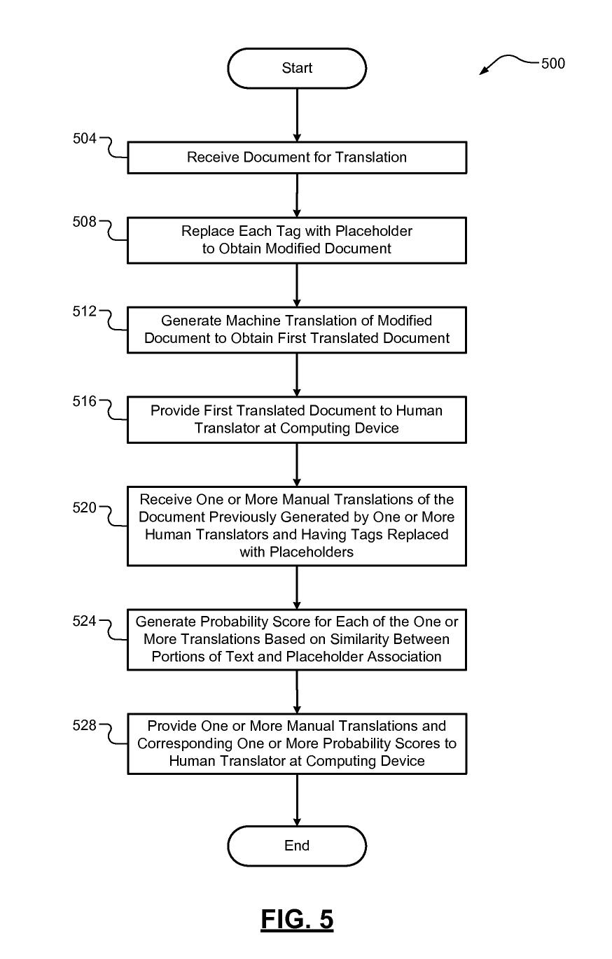

Referring now to FIG. 5, an example technique 500 for assisting the human translator 112 in translating a document including at least one tag is illustrated. At 504, the translation server 124 receives the document for translation from a source language to a target language. For example, the translation server 124 may receive the document from the web server 104 in response to a translation request from the computing device 116 operated by the human translator 112. The at least one tag can be associated with a first portion of text in the document. At 508, the translation server 124 replaces each tag of the document with a placeholder to obtain a modified document. At 512, the translation server 124 determines a machine translation of the modified document to obtain a first translated document, the first translated document having at least one placeholder associated with a second portion of text. At 516, the translation server 124 provides the first translated document to the human translator at the computing device 116.

At 520, the translation server 124 receives one or more manual translations of the document, which may have been previously generated by the one or more other human translators 128. In addition, each of the one or more manual translations may have had any tags replaced by placeholders, e.g., prior to being stored in the translation datastore 204. At 524, the translation server 124 generates a probability score for each of the one or more manual translations. The probability score for a specific manual translation can be based on a level of similarity between the second portion of text in the first translated document and a third portion of text in the specific manual translation of the document. Additionally or alternatively, the probability score can be based on whether the third portion of text has an associated placeholder. At 528, the translation server 124 provides the one or more manual translations (or the third portions of text) and the corresponding one or more probability scores to the human translator 112 at the computing device 116. Control may then end or return to 504 for one or more additional cycles.

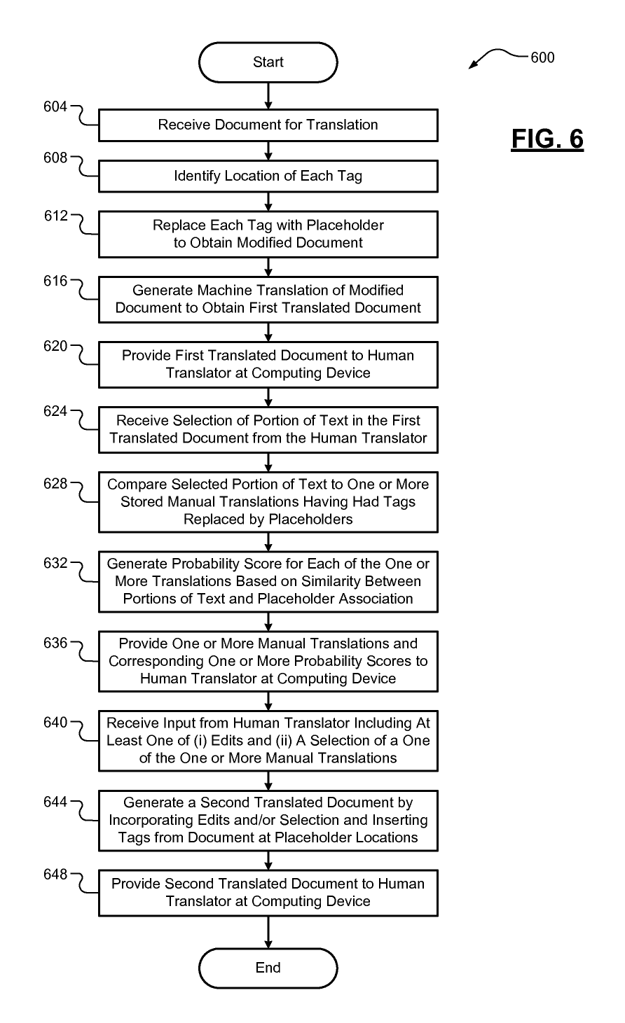

Referring now to FIG. 6, another example technique 600 for assisting the human translator 112 in translating a document including at least one tag is illustrated. At 604, the translation server 124 receives the document for translation from a source language to a target language. For example, the translation server 124 may receive the document from the web server 104 in response to a translation request from the computing device 116 operated by the human translator 112. The at least one tag may be associated with a first portion of text in the document. At 608, the translation server 124 identifies a location of each tag within the document. At 612, the translation server 124 replaces each tag with a placeholder at the corresponding identified location to obtain a modified document. At 616, the translation server 124 generates a machine translation of the modified document to obtain a first translated document. At 620, the translation server provides the first translated document to the human translator 112 at the computing device 116. At 624, the translation server 124 receives a selection of a second portion of text in the first translated document from the human translator 112 via the computing device 116, the second portion of text having an associated placeholder.

At 628, the translation server 124 compares the second portion of text to third portions of text of one or more manual translations of the document, each of the manual translations of the document having been previously generated by a human translator 128. In addition, each of the one or more manual translations of the document may have had any tags replaced by placeholders prior to being stored in the translation datastore 204. At 632, the translation server 124 generates a probability score for each of the one or more manual translations of the document. The probability score for a specific manual translation of the document can be based on a level of similarity between the second portion of text in the first translated document and a third portion of text in the specific manual translation of the document. Additionally or alternatively, the probability score for a specific manual translation of the document can be based on whether the specific manual translation of the document has a placeholder associated with the third portion of text. At 636, the translation server 124 provides the one or more manual translations of the document and the one or more corresponding probability scores to the human translator 112 at the computing device 116.

At 640, the translation server 124 receives input from the human translator 112 via the computing device 116. The input can include edits made by the human translator 112 to the second portion of text at the computing device 116. Additionally or alternatively, the input can include a selection of one of third portions of text of one of the manual translations of the document, e.g., based on the one or more probability scores. At 644, the translation server 124 generates a second translated document by incorporating edits made by the human translator 112 to the second portion of text of the first translated document at the computing device 116. Additionally or alternatively, the second translated document can be generated by replacing the second portion of text of the first translated document with the selected third portion of text from one of the manual translations of the document. The translation server 124 can then generate the second translated document by replacing each placeholder in the first translated document (with edits incorporated and/or selections inserted) with its corresponding tag from the document. At 648, the translation server 124 provides the second translated document to the human translator 112 at the computing device 116. Control may then end or return to 604 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The term module may include memory (shared, dedicated, or group) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for assisting a human translator in translating a document including at least one tag, the computer-implemented method comprising:
receiving, at a server including one or more processors, the document for translation from a source language to a target language, the at least one tag associated with a first portion of text in the document;
identifying, at the server, a location of each tag within the document;
replacing, at the server, each tag with a placeholder at the corresponding identified location to obtain a modified document;
generating, at the server, a machine translation of the modified document to obtain a first translated document;
providing, from the server, the first translated document to a computing device associated with the human translator;
receiving, at the server, a selection of a second portion of text in the first translated document by the human translator via the computing device, the second portion of text having an associated placeholder;
comparing, at the server, the second portion of text to one or more manual translations of the document, each of the one or more manual translations of the document having been previously generated by one or more other human translators, each of the one or more manual translations of the document having had any tags replaced by placeholders and being stored in a translation datastore;
generating, at the server, a probability score for each of the one or more manual translations of the document, the probability score for a specific manual translation of the document being based on (i) a level of similarity between the second portion of text in the first translated document and a third portion of text in the specific manual translation of the document and (ii) whether the specific manual translation of the document has a placeholder associated with the third portion of text;
providing, from the server, the one or more manual translations of the document and the one or more corresponding probability scores to the human translator at the computing device;
receiving, at the server, input from the human translator, the input including at least one of: (i) edits made by the human translator to the second portion of text at the computing device and (ii) a selection of one of third portions of text of one of the manual translations of the document based on the one or more probability scores;
generating, at the server, a second translated document by: (i) incorporating edits made by the human translator to the second portion of text of the first translated document, (ii) replacing the second portion of text of the first translated document with the selected third portion of text from one of the manual translations of the document, and (iii) replacing each placeholder in the first translated document with its corresponding tag from the document; and
providing, from the server, the second translated document to the human translator at the computing device.

2. A computer-implemented method, comprising:
receiving, at a server including one or more processors, a document for translation from a source language to a target language, the document including at least one tag associated with a first portion of text in the document;
replacing, at the server, each tag of the document with a placeholder to obtain a modified document;
obtaining, at the server, a machine translation of the modified document to obtain a first translated document, the first translated document having at least one placeholder associated with a second portion of text;
providing, from the server, the first translated document to a human translator at a computing device;
receiving, at the server, one or more manual translations of the document, the one or more manual translations having been previously generated by one or more other human translators, each of the one or more manual translations having had any tags replaced by placeholders;
generating, at the server, a probability score for each of the one or more manual translations, wherein the probability score for a specific manual translation is based on: (i) a level of similarity between the second portion of text in the first translated document and a third portion of text in the specific manual translation of the document and (ii) whether the third portion of text has an associated placeholder; and
providing, from the server, the one or more manual translations and the corresponding one or more probability scores to the human translator at the computing device.

3. The computer-implemented method of claim 2, wherein the probability score is within a first range of scores when the second portion of text is an exact match to the third portion of text and the third portion of text has an associated placeholder.

4. The computer-implemented method of claim 3, wherein the probability score is within a second range of scores when the second portion of text is an exact match to the third portion of text in the specific manual translation and the third portion of text does not have an associated placeholder, wherein the second range of scores is less than the first range of scores.

5. The computer-implemented method of claim 4, wherein the probability score is within a third range of scores when the second portion of text is a partial match to the third portion of text and the third portion of text has the associated placeholder, wherein the third range of scores is less than the second range of scores.

6. The computer-implemented method of claim 5, wherein the probability score is within a fourth range of scores when the second portion of text is a partial match to the third portion of text and the third portion of text does not have the associated placeholder, wherein the fourth range of scores is less than the third range of scores.

7. The computer-implemented method of claim 6, wherein the probability score within a particular one of the first, second, third, and fourth ranges of scores is based on the level of similarity between the second portion of text and the third portion of text.

8. The computer-implemented method of claim 2, further comprising providing, from the server, a pop-up window at a display of the computing device, the pop-up window overlaying the second portion of text selected by the human translator, the pop-up window configured to receive edits made by the human translator to the second portion of text.

9. The computer-implemented method of claim 8, further comprising receiving, at the server, input from the human translator via the computing device, the input including at least one of: (i) edits to the second portion of text and (ii) a selection of one of the one or more manual translations of the document.

10. The computer-implemented method of claim 9, further comprising generating, at the server, a second translated document by incorporating the input into the first translated document and by replacing each placeholder in the first translated document with its associated tag from the document.

11. The computer-implemented method of claim 10, further comprising providing, from the server, the second translated document to the human translator at the computing device.

12. A system, comprising:
a tag identification module that receives, at a server including one or more processors, a document for translation from a source language to a target language, the document including at least one tag associated with a first portion of text in the document;
a placeholder insertion module that replaces, at the server, each tag of the document with a placeholder to obtain a modified document;
a translation control module that
obtains, at the server, a machine translation of the modified document to obtain a first translated document, the first translated document having at least one placeholder associated with a second portion of text,
provides, from the server, the first translated document to a human translator at a computing device, and
receives, at the server, one or more manual translations of the document, the one or more manual translations having been previously generated by one or more other human translators, each of the one or more manual translations having had any tags replaced by placeholders; and
a translation scoring module that generates, at the server, a probability score for each of the one or more manual translations, wherein the probability score for a specific manual translation is based on: (i) a level of similarity between the second portion of text in the first translated document and a third portion of text in the specific manual translation of the document and (ii) whether the third portion of text has an associated placeholder,
wherein the translation control module provides, from the server, the one or more manual translations and the corresponding one or more probability scores to the human translator at the computing device.

13. The system claim 12, wherein the probability score is within a first range of scores when the second portion of text is an exact match to the third portion of text and the third portion of text has an associated placeholder.

14. The system of claim 13, wherein the probability score is within a second range of scores when the second portion of text is an exact match to the third portion of text in the specific manual translation and the third portion of text does not have an associated placeholder, wherein the second range of scores is less than the first range of scores.

15. The system of claim 14, wherein the probability score is within a third range of scores when the second portion of text is a partial match to the third portion of text and the third portion of text has the associated placeholder, wherein the third range of scores is less than the second range of scores.

16. The system of claim 15, wherein the probability score is within a fourth range of scores when the second portion of text is a partial match to the third portion of text and the third portion of text does not have the associated placeholder, wherein the fourth range of scores is less than the third range of scores.

17. The system of claim 16, wherein the probability score within a particular one of the first, second, third, and fourth ranges of scores is based on the level of similarity between the second portion of text and the third portion of text.

18. The system of claim 12, wherein the translation control module provides, from the server, a pop-up window at a display of the computing device, the pop-up window overlaying the second portion of text selected by the human translator, the pop-up window configured to receive edits made by the human translator to the second portion of text.

19. The system of claim 18, further comprising a translation selection module that receives, at the server, input from the human translator via the computing device, the input including at least one of: (i) edits to the second portion of text and (ii) a selection of one of the one or more manual translations of the document.

20. The system of claim 19, further comprising a tag insertion module that generates, at the server, a second translated document by incorporating the input into the first translated document and by replacing each placeholder in the first translated document with its associated tag from the document, and that provides, from the server, the second translated document to the human translator at the computing device.
